(19) United States
(12) Patent Application Publication
(10) Pub. No.: US 2018/0010935 A1
(43) Pub. Date: Jan. 11, 2018

(54) SYSTEM AND METHOD FOR IDENTIFYING AND CALIBRATING A SENSOR

(71) Applicant: Information is Power Pty Ltd., Glendale, NSW (AU)

(72) Inventors: Craig Robert Arnott, Sutherland, NSW (AU); Benjamin Carson Williams, Glendale, NSW (AU)

(73) Assignees: Information is Power Pty Ltd., Glendale, NSW (AU); Information is Power Pty Ltd., Glendale, NSW (AU)

(21) Appl. No.: 15/537,755

(22) PCT Filed: Dec. 15, 2015
(86) PCT No.: PCT/AU2015/050796

§ 371 Date: Jun. 19, 2017

(30) Foreign Application Priority Data
Dec. 19, 2014 (AU) 2014905165

(51) Int. Cl. G01D 18/00; G06F 21/44

(52) U.S. Cl. CPC G01D 18/008; G06F 21/44

(57) ABSTRACT

A method, system, server and computer program product for the calibration of a sensor of a building. In particular, the method may include: receiving, at the computer system, sensor identification data, the identification data provided by communication of an identifier associated with the sensor and an identification device configured to communicate with the system; receiving, at the computer system, measured data representing a calibration sensor device measured physical phenomenon provided by communication of a portable calibration sensor device with an environment proximate to the sensor, the portable calibration sensor device being configured to communicate with the system; and receiving, at the computer system, sensor data associated with the identification data of the sensor, the sensor data representing a sensor measured physical phenomenon provided by the sensor; calculating, in the computer system, a difference value between the measured data and the sensor data so as to provide calibration data.

### RELATED APPLICATIONS

This application claims priority from Australia provisional patent No. 2014905165 filed 19 Dec. 2014, the contents of which are incorporated by reference.

### TECHNICAL FIELD

The invention relates to a system, method and computer program product for identifying and calibrating a sensor, in particular, a sensor of a building in communication with a Building Management System (“BMS”).

### BACKGROUND

Buildings are often fitted with a series of sensors that measure physical phenomenon or parameters of the environment within the building. Such physical phenomenon includes, but is not limited to, temperature, pressure, humidity and carbon dioxide levels. The array of sensors output measured data representing the physical phenomenon to a generally centralised computing system is often referred to as a Building Management System or BMS.

Building Management Systems are typically closed systems which monitor and record information about a building or multiple buildings including the sensor measured data. The array of sensors of a Building Management System are networked within and report directly to the Building Management System and are typically closed to external inputs or outputs.

To ensure that the array of sensors is outputting the correct sensor measured data it is necessary to calibrate each of the sensors at periodic intervals. Currently, the process to calibrate the building sensors involves maintenance personnel manually identifying a particular sensor and taking a measurement using a separate calibration instrument placed proximate to the particular sensor or otherwise connected so as to measure the physical condition for which the BMS sensor is measuring. For example, the temperature is measured near to a particular temperature sensor.

The measured instrument data is then manually compared to the data output of the sensor stored on the building management system to determine any differences between the measured sensor data and the measured calibration instrument data. If a difference is identified, calibration data including a calibration offset may be introduced into the building management system so that the sensor data is substantially equal to the measured calibration instrument data.

A problem with the above method is that the manual operators are time consuming and may introduce errors into the system. Another problem is that a Building Management System is often a closed system that operates across several buildings and it is difficult for maintenance personal to know the identity, type and status of the sensors to ensure the correct calibration data is collected. It is then difficult to ensure the correct calibration data is applied to Building Management System and the correct time and date of calibration is recorded for future reference.

A further problem with the above method is ensuring that the measuring instrument being used has been calibrated by a certified calibration agent within a reasonable period of time. Typical practice is for a paper certificate to be issued to the owner/user of the measuring instrument to serve as evidence of the date of certified calibration of the instrument. This paper certificate can be lost or altered and must be physically transferred to or sighted by building owners and facility managers to ensure that the measuring instrumentation calibration is current and certified.

The invention disclosed herein seeks to overcome one or more of the above identified problems or at least provide a useful alternative.

### SUMMARY

In accordance with a first main aspect there is provided, a method for calibration a sensor of a building using a computer system, the method including the steps of: a) receiving, at the computer system, sensor identification data, the identification data provided by communication of an identifier associated with the sensor and an identification device configured to communicate with the system; b) receiving, at the computer system, measured data representing a calibration sensor device measured physical phenomenon provided by communication of a portable calibration sensor device with an environment proximate to the sensor, the portable calibration sensor device being configured to communicate with the system; and c) receiving, at the computer system, sensor data associated with the identification data of the sensor, the sensor data representing a sensor measured physical phenomenon provided by the sensor; d) calculating, in the computer system, a difference value between the measured data and the sensor data so as to provide calibration data.

In an aspect, the method further includes the step of: storing, in the computer system, the calibration data including the difference value in a database such that the sensor data is offset in value to substantially match the measured data.

In another aspect, the method further includes the step of: receiving, at the computer system, device authorisation data associated with at least one of the identification device and the portable calibration sensor device; and determining, a device authority associated with device authorisation data by comparing the device authorisation data with pre-determined device authorisation data, the device authority enabling calibration of the sensor data.

In yet another aspect, the method further includes the steps of: receiving, at the computer system, user authorisation data associated with a user of at least one of the identification device and the portable calibration sensor device; and determining, a user authority associated with user authorisation data by comparing the user authorisation data with pre-determined user authority data, the user authority enabling calibration of the sensor data.

In yet another aspect, the method further includes the steps of: receiving, at the computer system, calibration validity data associated with the portable calibration sensor device; and determining, in the computer system, a calibration validity associated with calibration validity data by comparing the calibration validity data with pre-determined calibration validity data, the calibration validity enabling calibration of the sensor data.

In yet another aspect, the identifier is an optically readable code and the identification device is a camera of a mobile device.

In yet another aspect, the portable calibration sensor device is at least one of a temperature, light, pressure and gas sensor.

In yet another aspect, the first and second physical phenomenon measurements are each at least one of temperature, light, pressure and gas levels.

In accordance with a second main aspect there is provided, a method for calibration of sensor data on a building management system database using a computer system configured to interface with the building management system database, the method including, in the computer system the steps of: a) receiving, sensor identification data, the identification data provided by communication of an identifier associated with the sensor and an identification device configured to communicate with the system; b) receiving, measured data representing a calibration sensor device measured physical phenomenon provided by communication of a portable calibration sensor device with an environment proximate to the sensor, the portable calibration sensor device being configured to communicate with the system; and c) receiving, from the building management system database, sensor data associated with the identification data of the sensor, the sensor data representing a sensor measured physical phenomenon provided by the sensor identified; d) calculating, in the computer system, a difference value between measured data and the sensor data so as to provide calibration data; e) sending, the calibration data including the difference value to the building management system database such that the sensor data is offset in value to substantially match the measured data.

In accordance with a third main aspect there is provided, a computed implemented method for calibration of sensor data on a building management system database using a computer system configured to interface with the building management system database, the method including, in the computer system the steps of: a) receiving, sensor identification data, the identification data provided by communication of an identifier associated with the sensor and an identification device configured to communicate with the system; b) receiving, measured data representing a calibration sensor device measured physical phenomenon provided by communication of a portable calibration sensor device with an environment proximate to the sensor, the portable calibration sensor device being configured to communicate with the system; and c) receiving, from the building management system database, sensor data associated with the identification data of the sensor, the sensor data representing a sensor measured physical phenomenon provided by the sensor identified; d) calculating, in the computer system, a difference value between measured data and the sensor data so as to provide calibration data; e) sending, the calibration data including the difference value to the building management system database such that the sensor data is offset in value to substantially match the measured data.

In accordance with a fourth main aspect there is provided, a system for the identification and calibration of a sensor of a building, the system including a mobile computing system and a server processing system, wherein the mobile computing system includes an identification device configured to read an identifier associated with the sensor to provide identification data, and a calibration sensor device configured to sample a first physical phenomena proximate to the sensor so as to provide calibration sensor data representative of the first physical phenomena, and wherein the server processing system includes a server and a database, the server is configured to receive the identification data and the calibration sensor data, and retrieve sensor data associated with identification data from the database, the sensor data representing a second physical phenomena as measured by the sensor of the building, and wherein the server is further configured to calculate a difference value between the calibration sensor data and the sensor data so as to provide calibration data and store the calibration data including the difference value in a database such that the sensor data is offset in value to substantially match the calibration sensor data

In an aspect, the system is configured to: receive device authorisation data associated with at least one of the identification device and the calibration sensor device; and determine, a device authority associated with the device authorisation data by comparing the device authorisation data with pre-determined device authorisation data, the device authority enabling calibration of the sensor data.

In another aspect, the system is configured to: receive user authorisation data associated with a user of at least one of the identification device and the calibration sensor device; and determine a user authority associated with the user authorisation data by comparing the user authorisation data with pre-determined user authority data, the user authority enabling calibration of the sensor data.

In yet another aspect, the system is configured to: receive calibration validity data associated with the portable calibration sensor device; and determine a calibration validity associate with the calibration validity data by comparing the calibration validity data with pre-determined calibration validity data, the calibration validity enabling calibration of the sensor data.

In yet another aspect, the identifier is an optically readable code and the identification device is a camera of a mobile device.

In accordance with a fifth main aspect there is provided, a computer program product for a sensor identification and calibration system, the computer program product including executable computer code to configure the system to: a) receive sensor identification data, the identification data provided by communication of an identifier associated with the sensor and an identification device configured to communicate with the system; b) receive measured data representing a calibration sensor device measured physical phenomenon provided by communication of a portable calibration sensor device with an environment proximate to the sensor, the portable calibration sensor device being configured to communicate with the system; and c) receive sensor data associated with the identification data of the sensor, the sensor data representing a sensor measured physical phenomenon provided by the sensor; d) calculate a difference value between measured data and the sensor data so as to provide calibration data; e) store the calibration data including the difference value in a database such that the sensor data is offset in value to substantially match the measured data.

In accordance with a sixth main aspect there is provided, a computer program product for a mobile device, the computer program product including executable computer code to configure the mobile device to: a) receive sensor identification data, the identification data provided by communication of an identifier associated with the sensor and an identification device configured to communicate with the system; b) receive measured data representing a calibration sensor device measured physical phenomenon provided by communication of a portable calibration sensor device with an environment proximate to the sensor, the portable calibration sensor device being configured to communicate with the system; and c) receive sensor data associated with the identification data of the sensor, the sensor data representing a sensor measured physical phenomenon provided by the sensor; d) calculate a difference value between measured data and the sensor data so as to provide calibration data; e) store the calibration data including the difference value in a database such that the sensor data is offset in value to substantially match the measured data.

In accordance with a seventh main aspect there is provided, a computer program product for a mobile device in communication with a server processing system, the computer program product including executable computer code to configure the mobile device to: a) receive sensor identification data, the identification data provided by communication of an identifier associated with the sensor and an identification device configured to communicate with the mobile device; b) receive measured data representing a calibration sensor device measured physical phenomenon provided by communication of a portable calibration sensor device with an environment proximate to the sensor, the portable calibration sensor device being configured to communicate with the mobile device; and c) communicate, the sensor identification data and the measured data to the server system to be processed such that the server system retrieves sensor data associated with the identification data of the sensor, the sensor data representing a sensor measured physical phenomenon provided by the sensor, calculates a difference value between measured data and the sensor data so as to provide calibration data and stores the stores the calibration data including the difference value in a database such that the sensor data is offset in value to substantially match the measured data.

In accordance with a eighth main aspect there is provided, a server processing system for calibration a sensor of a building, the server processing system being configurable by computer code to: a) receive sensor identification data, the identification data provided by communication of an identifier associated with the sensor and an identification device configured to communicate with the system; b) receive measured data representing a calibration sensor device measured physical phenomenon provided by communication of a portable calibration sensor device with an environment proximate to the sensor, the portable calibration sensor device being configured to communicate with the system; and c) receive sensor data associated with the identification data of the sensor, the sensor data representing a sensor measured physical phenomenon provided by the sensor; d) calculate a difference value between measured data and the sensor data so as to provide calibration data; and e) store, the calibration data including the difference value in a database such that the sensor data is offset in value to substantially match the measured data.

In accordance with a ninth main aspect there is provided, a method for calibration of a sensor of a building using a mobile computing device computer system and an associated calibration sensor device, the method including the steps of: receiving, at the mobile computing system, sensor identification data, the identification data provided by communication of an identifier associated with the sensor and an identification device of the mobile computing system; determining, at the mobile computing system, if the mobile computing system is in at least one of an online mode and offline mode; wherein, in the online mode, the mobile computing system is configured to communicate with a server system to perform a validation routine including at least one of a sensor identification, user identification and a calibration check of the associated calibration sensor device, the validation routine enabling measured data representing a calibration sensor device measured physical phenomenon provided by communication of the calibration sensor device with an environment proximate to the sensor to be validly recorded by the server system; and wherein, in the offline mode, the measured data is recorded and at least temporality stored by the mobile computing system such that once the mobile computing system is returned to the online mode the server system performs the validation routine so as to validly record the measured data.

### BRIEF DESCRIPTION OF THE FIGURES

The invention is described, by way of non-limiting example only, by reference to the accompanying figures, in which;

FIG. 1 is a functional block diagram illustrating a computer processing system suitable for operating various examples of the method for the identification and calibration of a sensor;

FIG. 2 is a system diagram illustrating a system for the identification and calibration of a sensor in communication with a building management system.

FIGS. 3a and 3b are a process flow diagrams representing an example of a method for the identification and calibration of a sensor;

FIG. 4 is a process flow diagram representing an example of a method for the identification and calibration of a sensor as preferably performed by a server processing system;

FIG. 5 is a process flow diagram representing an example of a method for identification of the building sensor;

FIG. 6 is a process flow diagram representing an example of a method for authorisation of a user of the system; and

FIG. 7 is a process flow diagram representing an example of a method for checking the validity of a calibration certificate of a calibration sensor device of the identification and calibration system.

### DETAILED DESCRIPTION

The following example and forms, given by way of example only, are described in order to provide a more precise understanding of the subject matter of a preferred example or example methods and computer systems. In the figures, incorporated to illustrate features of an example form, like reference numerals may be used to identify like parts.

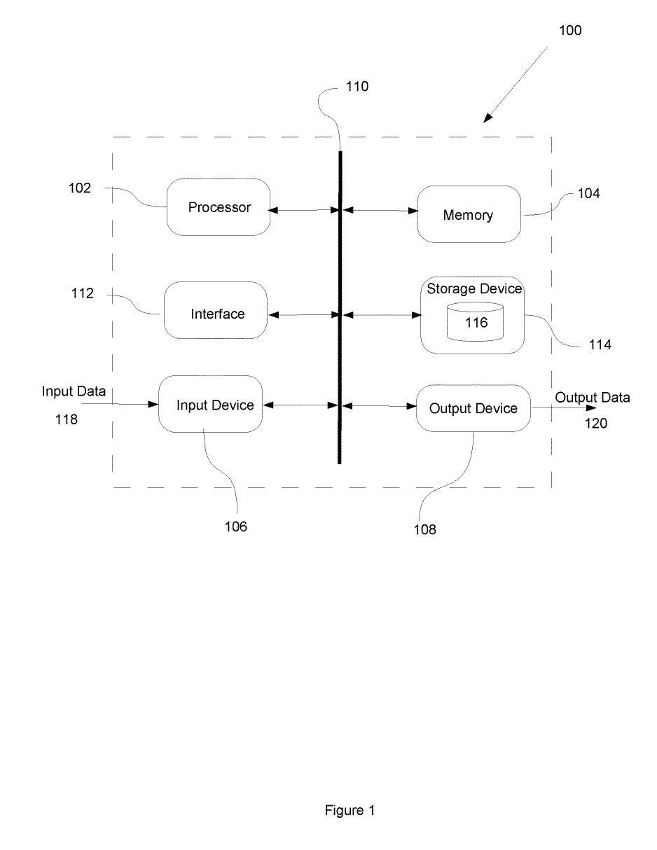

Referring to FIG. 1, there is shown an example of a computing device or system 100 on which the various example methods and computer systems described herein may be implemented.

The computing device or system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for communicating the system 100 to one or more peripheral devices, for example interface 112 could be a PCI card or PC card. At least one storage device 114 which includes at least one database 116 can also be provided. The memory 104 can be any form of memory device, for example, volatile or non-volatile memory, solid state storage devices, magnetic devices, etc. The processor 102 could include more than one distinct processing device, for example to handle different functions within the system 100.

Input device 106 receives input data 118 and can include, for example, a keyboard, camera, video, touch screen, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor. The storage device 114 can be any form of data or information storage means, for example, volatile or non-volatile memory, solid state storage devices, CD-ROM disks, magnetic media such as floppy disks and tape cassettes or flash media such as USB memory sticks. The database 116 may be one or more MSQL databases or the like.

In use, the computer system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the system 100 may be or included within any form of computing device, mobile computing device, terminal, server, specialised hardware, or the like. Prior to or during operation of the method described herein the computer program code instructions or a computer code product may be loaded into the storage device 106 which configures the system 100 to operate the methods, as computer implemented methods, as described herein.

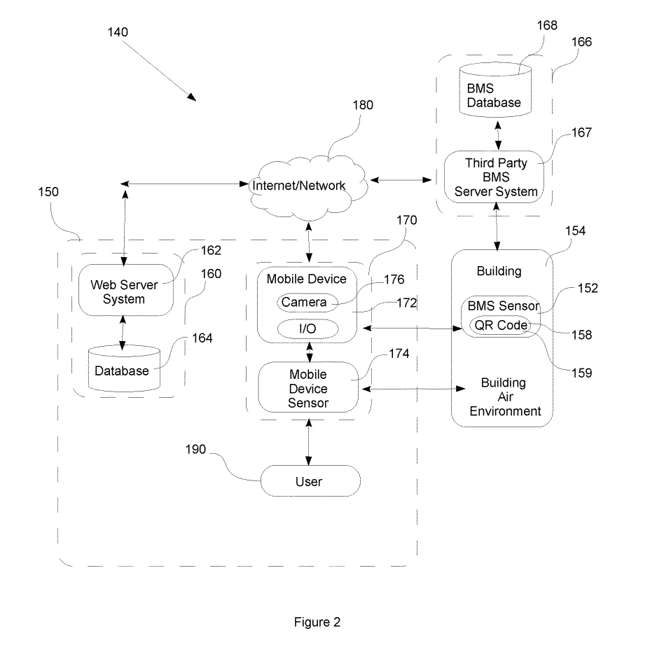

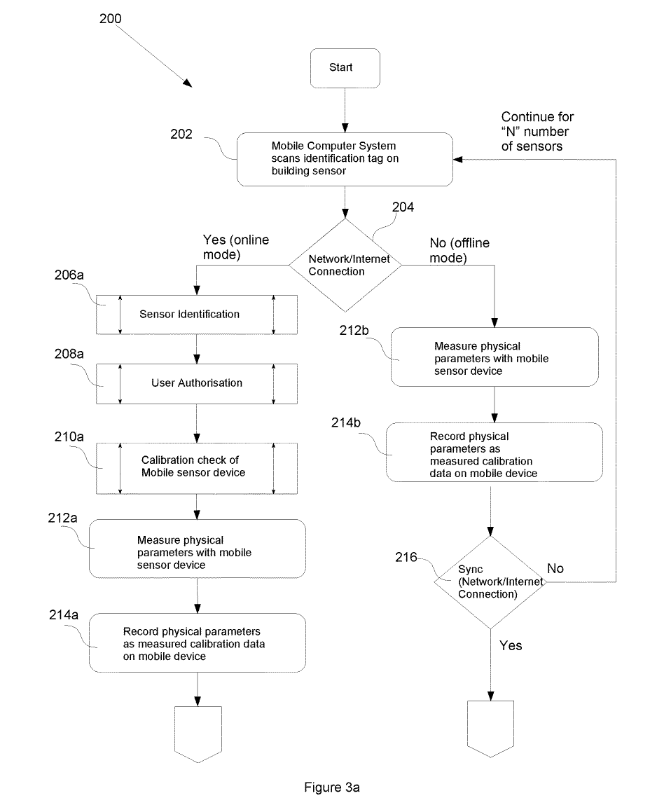

Referring to FIG. 2 there is illustrated a block diagram representing a system 140 for the identification and calibration of one or more sensors 152 in a building 154. The system 140 includes a sensor identification and calibration system 150 in communication with an existing Building Management System 166 (BMS). The system 140 includes one or more of the computer system 100 as described above.

The sensor identification and calibration system 150 includes a server system 160 in data communication over the network/internet 180 with a mobile computer system 170 configured for operation by a user 190.

The server system 160 may include a webserver 162 and an application server 163. The application server 163 may be a mobile application server. Other configurations of the server system 160 are also possible and may include any number of servers. The web-server 162 and/or application server 163 includes a computer system 100 as described above adapted for the server environment and a server database 164 which stores building and sensor information data, as is further described below. The server system 160, preferably via the application server 163, is configured to operate application software including a website and interface with application software operated by the mobile computer system 170.

The server system 160 is configured, by application software, to interface, over the network/internet 180 with the existing Building Management System 166 (BMS) which includes a BMS server system 167, which may be or include a webserver, in communication with the plurality of building sensors 152 and a BMS database 167 which stores building and sensor information, as is further described below. The BMS system 166 and/or the BMS system 167 include one or more computer system 100. Preferably, the interface maintains the BMS database 167 and the server database 164 as mirrors of one another or at least partial mirrors for data relating to the sensors 152 registered for operation with the system 150.

The plurality of sensors 152 may be located respectively at one or more buildings 154. Typically, each building 156 may have many sensors 152 numbering in the hundreds and each BMS 166 may receive and store information from many different buildings 156. It is noted that a single building 154 and single sensor 152 are shown in FIG. 2 for diagrammatic purposes only and the BMS 166 is typically in communication with a plurality of buildings 154 which each have a plurality of sensors 152.

The sensors 152 are configured to output measured sensor data representative of physical phenomenon within the building 154 such as air temperature, air pressure and carbon dioxide levels. The measured sensor data includes information such as a building identifier, location or floor identifier, a sensor identifier, time & date information and the measured physical phenomenon signals representative of air temperature, air pressure and carbon dioxide levels. The measured sensor data is typically used to monitor and operate building systems, in particular, air conditioning and ventilation systems.

In this example, the system 140 includes computer or device readable identifier or identification part 158 fitted to or located at each of the sensors 152. In this example the identification part 158 is an optically readable code in the form of a matrix bar code such as a QR-Code™ 159. However, other identification parts, devices or codes may be utilised such as other types of Bar-codes, alpha-numeric codes or Radio Frequency Identification Devices (RFID's).

The identifier or identification part 158 includes a unique identifier code or identification data that allows a particular sensor 152 to be identified as is further described below. Accordingly, to operate the sensor identification and calibration system 150, the sensors 152 are firstly fitted with the QR-Codes which are readable by the mobile computing system 170. The QR-codes are typically located on adhesive tags which are adhered to the sensors 152.

The mobile computer system 170 includes a mobile computer device 172 and a calibration or sensor device 174 for measuring a physical phenomenon such as air temperature, air pressure and carbon dioxide levels. The mobile computer system 170 also includes an identification device or identification reader 176, such as a QR-Code scanner or an RFID reader. In some examples, the identification device 176 may be a stand-alone identification device 176 in communication with the mobile computing device 172. However, in this example, the identification device 176 is preferably a camera 178 of the mobile computing device 172 configured to read the QR-code.

The mobile computer device 172 includes a computer system 100 as described above and the camera 178 configured to take digital images of a QR-Code, located and at least temporarily store these images in the computer system 100 carried by the mobile computer system 170. In a preferred form, the user downloads a computer program, commonly known as a downloadable computer application or “App”, which is installed in the memory of the mobile computer device 172 which is used to operate the graphical user interface of the mobile computer device 172 and the server system 160. Such cameras 178 and QR-Code reading functionality of web-enabled smart-phones, tablets or similar device is well known and is not described here in further detail.

The calibration sensor 174 may be a stand-alone device in communication with the mobile computer device 172 or may be integral with the mobile computer device 172. In this example, the calibration sensor 174 is preferably a stand-alone device configured for communication with the mobile computer device 172 and the mobile computer device 172 is preferably a web-enabled smart-phone, tablet or similar mobile computing device. The calibration sensor 174 may communicate with the mobile computer device 172 via an input/output port 177 (I/O) of the mobile computer device 172 or via Bluetooth™ or other wireless I/O means.

The calibration sensor 174 is preferably a physical apparatus configured to measure physical conditions (pressure, temp, CO², etc). An example of temperature sensor directly connectable to a smart phone is commercially available from Thermodo™, and an example of a temperature and humidity sensor is commercially available from BeeWi™, having the model number BBW200, communicable to a smart phone via Bluetooth™. Further examples of sensors that connect to a smart phone or tablet via WiFi™ are available from Fluke™ such as the t3000 FC Wireless K-Type Temperature Meter.

In some examples, the software on the mobile device 172 may operate and configure the calibration sensor 174 and, the calibration and identification information is stored on the calibration device 174. The mobile device 172 references the calibration information and sensor device identification information to: a) confirm the devices 174 calibration (when, where, by whom, etc as entered by the calibration agent at the time of calibration, information that is stored on the server system 160, not on the sensor itself, the sensor only has identification info in this regard; and b) apply the calibration information as it uses the input data from the calibration sensor device 174. There may be several grades of calibration sensors, some with temperature only, some with multiple sensors and would be modular for expansion or change-out of defective/damaged components. The configuration may include a range of different grades and types of components that could be attached to the base-sensing device, depending on user preferences.

The mobile computer system 170 is configured by the application software to communicate or send the QR-Code to the external server processing system 160 for authentication and matching the information associated with the particular sensor 152. The database 164 of the server processing system 160 includes data such as look-up tables or mapping data to associate a particular QR-Code with each of the sensors 152 and then further look-up tables or mapping data to link the identified sensor 152 with sensor data stored on the BMS 166 or mirrored on the webserver database 164.

This allows the server processing system 160 to retrieve sensor information from a particular sensor 152, such as the sensor-measured data, from the BMS system 166. The server processing system 160 may also write data, such as calibration data for a particular identified sensor 152 to the BMS system 166, as is further described below. Accordingly, the sensor identification and calibration system 150 may be used to identify and calibrate sensors 152, more specifically sensor data outputted from the sensors, of an existing BMS system 166 as is further detailed in the example methods below.

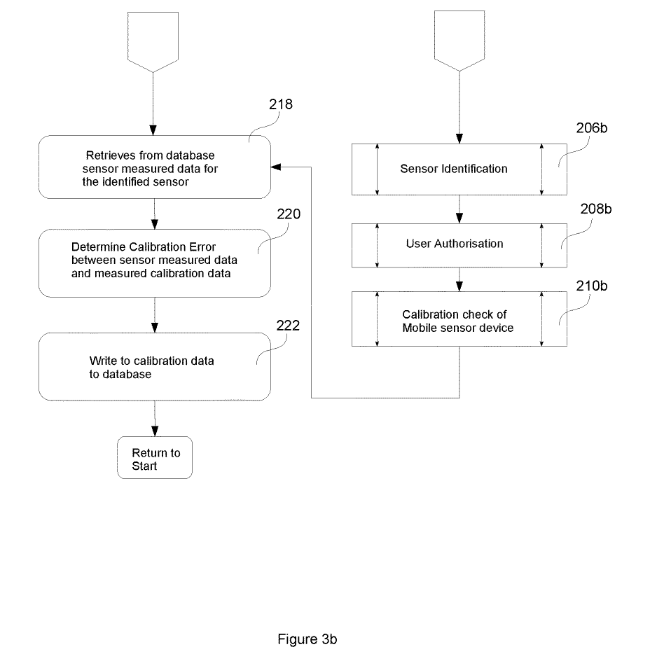

Referring to FIGS. 3a and 3b, there is shown a flowchart representing an example method 200 of utilising the sensor identification and calibration system 150 to identify and calibrate a sensor 152.

The method 200 includes, at step 202, capturing or scanning the Q-Code using the camera of the mobile computer system 170. Typically, this includes the user 190 placing the camera of the mobile computer system 170 proximate to the Q-Code of the particular sensor 152.

At step 204, the mobile computer system 170, configured by the application software, determines if the operations will be in “online” mode or “offline” mode. In online mode, the mobile computer system 170, is able to communicate via the internet/network 180 with the server processing system 160. Whilst in the offline mode, the mobile computer system 170, is configured to operate as a data storage and collection device which is then later “synced” with the server processing system 160. The two modes are advantageous because whilst within a building the network signal such as 3G, 4G or a Wi-Fi signal may be lost or intermittent.

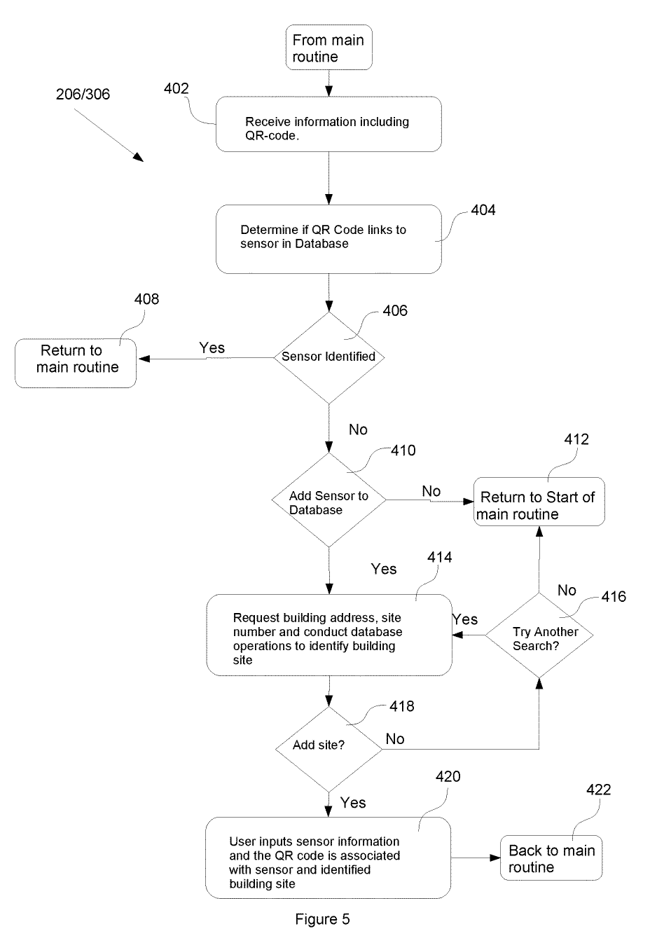

At step 206a, the system 150, configured by the application software, performs a sensor identification routine where the scanned Q-Code identification data is communicated with the server processing system 160 to determine if the particular Q-Code is registered with the server processing system 160. The sensor identification routine is further described below with reference to FIG. 5.

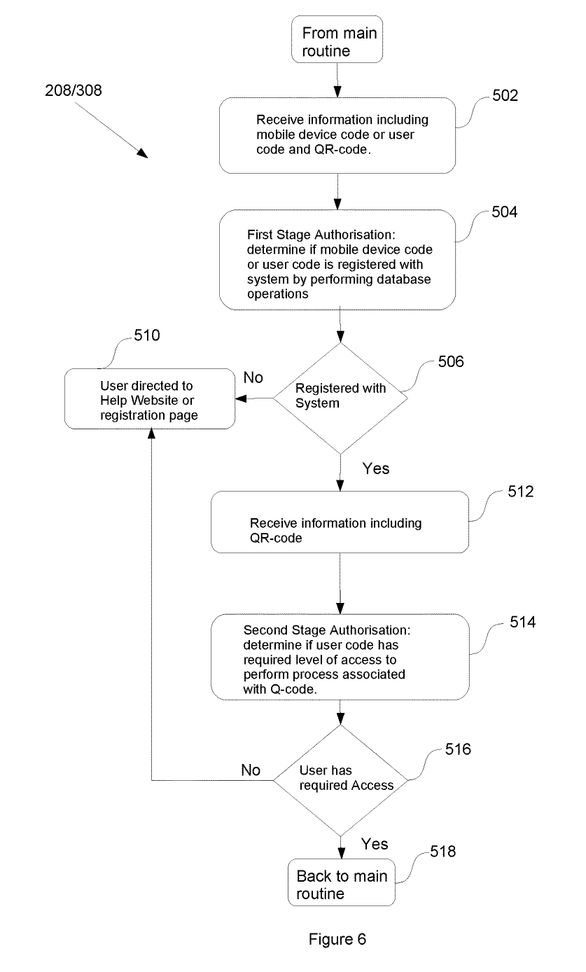

At step 208a, the system 150, configured by the application software, performs a user authorisation routine to ensure that the particular user and/or the mobile computer system 170 is registered with the sensor identification and calibration system 150. The user authorisation routine is further described below with reference to FIG. 6.

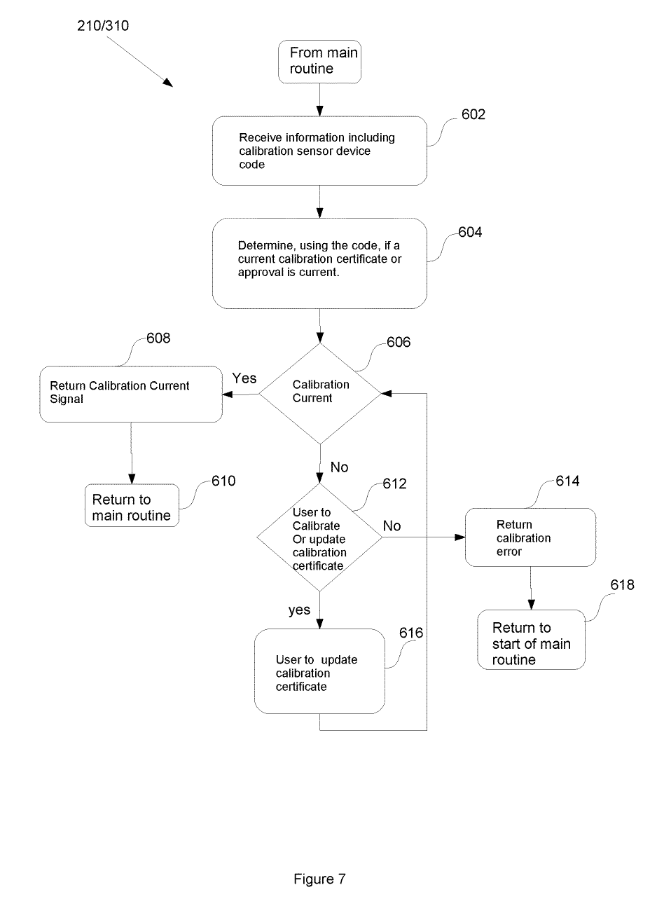

At step 210a, the system 150, configured by the application software, performs a calibration check of the calibration sensor device 174 of the mobile computer system 170 to ensure that the calibration sensor device 174 is itself currently calibrated and has a currently issued calibration certificate. If the calibration is out of date or otherwise invalid an error message is returned to the user. The calibration check routine is further described below with reference to FIG. 7.

A step 212, a calibration sensor device 174 of the mobile computer system 170 is utilised to perform a measurement step where the environment proximate to the identified sensor 152 is sampled to provide measured data including a first physical phenomenon measurement such as temperature or pressure. This measurement step involves the user positioning the calibration sensor device 174 to a suitable location or position proximate to the identified sensor 152 and enabling the calibration sensor device 174 to undertake a sensing or measuring operation. For example, the mobile device application software may control the calibration sensor device 174 to enable the sensing or measuring operation and store the measured calibration sensor data.

At step 214, the measured calibration sensor data is at least temporarily stored on the mobile device 170 and may be stored as a dataset containing multiple readings from multiple sensors 152 or the measured data may be communicated to the server processing system 160 for further processing and storage.

In the “offline-mode”, the mobile computer system 170 is, at least temporarily, unable to communicate with the server processing system 160. Accordingly, the system 150 does not preform the sensor identification, user authorisation or calibration check steps until the mobile computer system 170 “syncs” with the server processing system 160 at synchronisation step 216. However, in the “offline-mode” the mobile computer system 170, is configured by the application software, to act as a sampling device and perform steps 212b and step 214b which are substantially similar to steps 212a and 214a as described above. Accordingly, the calibration sensor device 174 of the mobile computer system 170 may be utilised to collect a calibration dataset for particular identified sensors and the measured data set is then stored on the mobile computer system 170 until synchronisation step 216. If the mobile computer system 170 is not synchronised then the mobile computer system 170 may be used to collect data from many different sensors 152.

At step 216, the mobile computer system 170 “syncs” with the server processing system 160 which initiates the sensor identification step 206b, user authorisation step 208b and calibration check step 210b which are substantially similar to steps 206a, 208a and 210a as described above. However, the mobile computer system 170 may have collected a large data set that requires a longer period of time to be processed. Accordingly, in situations where large datasets are collected, it may be preferable to conduct the synchronisation at a later time and/or via a hardwired connection.

At step 218, the system 150 retrieves the current sensor data including a second physical phenomenon measurement, such as temperature or pressure, measured by the identified sensor 152. In this step, the system 150 utilises the Q-Code to identify the sensor and then perform database operations to retrieve the relevant second physical phenomenon measurement. The system 150 preferably retrieves the current sensor data from the webserver database 164. However, the system 150 may also retrieve the current sensor data from the BMS server 167 and preferably updates the webserver database 164 accordingly. The server processing system 160 preferably performs the database operations and the retrieved data may be at least temporarily stored in memory of the server processing system 160 or communicated to the mobile communication system 170.

At step 220, the system 150, preferably the server processing system 160, determines or calculates a difference or offset value between the measured calibration sensor data representative of the first physical phenomenon measurement provided by the calibration sensor device 174 and the sensor data representative of the second physical phenomenon measurement provided by the identified building sensor 152 to provide calibration data for calibrating the identified sensor 152.

For example, the sensor data temperature reading provided by the BMS may be 18 degrees and the measured calibration sensor data temperature reading of the calibration sensor device 174 may be 19.5 degrees. The difference is then 1.5 degrees. Accordingly, the calibration data will include an offset value of +1.5 degrees. The application software may be configured to display via the mobile computer system 170, the current sensor data, the measured data and the calibration data. The application software may also be configured to display a prompt to enable the user to accept or reject the calculated calibration data. It is noted that the calculation of the calibration data may be performed on the mobile computer system 170, the server system 160 or another suitable computer device of the system 140.

A step 222, the calibration data is stored on the webserver database 164 and may be communicated with the BMS system. The calibration data provides offset values are applied or written the BMS database to ensure the BMS sensor data matches or is substantially similar to the measured data. If the calibration data is calculated by the mobile computer system 170 of the processing system 150, then the calibration data is firstly communicated to the webserver 162 and then communicated with the BMS 166. The calibration data may also include a time/date data, user data and calibration sensor data to record when, who and how the identified sensor 152 was calibrated.

At the completion of the process, the routine returns to the start and the user 190 may be promoted to either “scan next sensor” or “finish”.

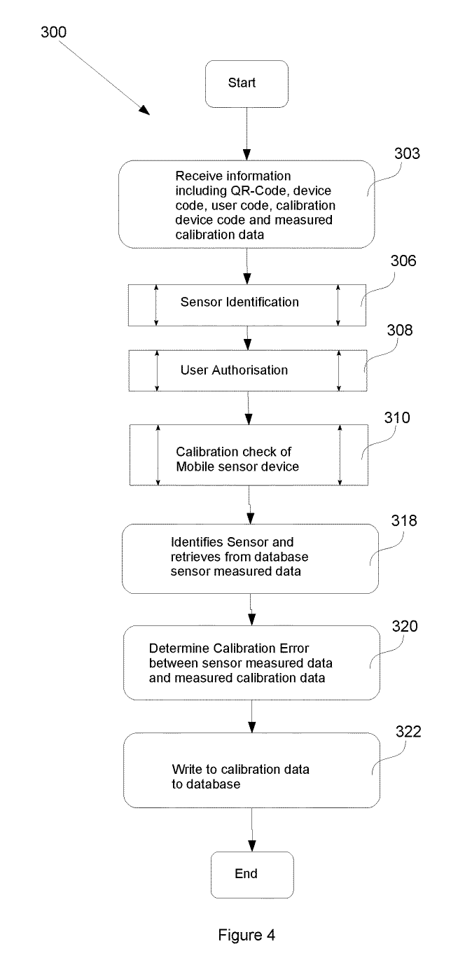

Referring now to FIG. 4, there is shown a flowchart representing an example method 300 as performed by the sensor identification and calibration system 150 to identify and calibrate a sensor 152 of the building 154. In this example, the processes are predominately run on the server processing system 160. However, the processes may be run on the mobile device 172 in combination with the webserver 162.

The method 300 includes, at step 303, the system 150, preferably the server system 160, receives at or by the server system 160 information including or representing an identifier which may be, for example, a QR-Code for a particular scanned building sensor 152, a device code associated with the mobile device 172, the user code associated with the user account of the application software operated by the mobile device 172, the calibration device code associated with the calibration sensor device 174, and measured calibration sensor data obtained or collected with the calibration sensor device 174. The received information is typically received by the webserver 162 and may be stored in memory of the webserver 162 and/or the webserver database 164.

At step 306, the system 150, preferably the webserver 162 of the server processing system 160, performs a sensor identification routine where the read or scanned identifier 158 in the form of a QR-Code 159 is matched with pre-determined identification data being pre-determined QR-Code data stored on the server database 164 to determine if the particular QR-Code, and hence sensor 152, is registered with the server processing system 160. The sensor identification routine is further described below with reference to FIG. 5.

At step 308, the system 150, preferably the server processing system 160, performs a user authorisation routine to ensure that the particular user and/or mobile computer system 170 is registered with the sensor identification and calibration system 150. The user authorisation routine is further described below with reference to FIG. 6.

At step 310, the system 150, preferably the server processing system 160, performs a calibration check of the calibration sensor device 174 of the mobile computer system 170 to ensure that the calibration sensor device 174 is itself currently calibrated and has a currently issued calibration certificate. If the calibration is out of date an error message is returned to the user. The calibration check sub-routine is further described below with reference to FIG. 7.

At step 318, system 150, preferably the server processing system 160, retrieves the current sensor data including a second physical phenomenon measurement, such as temperature or pressure, measured by the identified sensor 152. This step is substantially similar to step 218 described above and is not again described here.

A step 320, the system 150, preferably server processing system 160, determines or calculates a difference value between a first physical phenomenon measurement, such as temperature, of the calibration sensor date. The difference is provided in the form of calibration data. This step is substantially similar to step 220 described above and is not again described here.

A step 322, the system 150, preferably server processing system 160, stores the calibration data on the webserver database 162 and may be communicated with the BMS 166. Again, this step is substantially similar to step 222 described above and is not again described here

Referring now to FIG. 5, the sensor identification routine 206, 306 is described in further detail as method 400. At step 402, the system 150 receives identification information or data that in the example of a QR-code includes QR-code data. This system 150, preferably server processing system 160, performs processing and database operations to determine if the QR-code data is located within the server database 164 and linked or mapped to a particular sensor 152.

At step 406, the routine returns either a sensor-identified signal and returns to the main routine 408. Or, a sensor unidentified signal in which case the system 150 may return a prompt or signal to enable the addition of the sensor 152 to the database 164, at step 410. Depending on how the system 150 is configured, the prompt may be displayed on the mobile device 172 for action by the user 190. If the sensor 152 is not added to the system 150, then the routine returns to the start of the main routine which may be main routine 200 or 300.

If the user prompt response is to add a the sensor 152, the system 150 is configured to generate data such as a form to request information about the building address, site number and conduct database search operations to identify the building site. At step 148, the system 150 is configured to display a particular identified site from the database operations. At step 418, the system 150 is configured to provide prompts to user to accept or decline the identified building site. If the identified building site is declined the system 150 may provide further prompts, at step 416, for the user to perform another building site search.

If the identified building site is selected, at step 420, the system 150 is configured to generate further data such as a form to enable the user to input sensor information and any codes associated with the sensor to allow the mapping of the database 164 with the BMS database 168. At step 422, the routine then returns to the main routine 200 or 300.

Referring now to FIG. 6, the user authorisation routine 208, 308 is described in further detail as method 500. At step 502, the system 150 receives information including the QR-code, a mobile device code or a user code. The system 150, preferably server processing system 160, performs processing and database operations to determine if the mobile device code or a user code is registered and authorised with the system 150 by conducting lookup operations of the server database 164. It is noted the system 150 includes a registration system which operated via a website operated by the webserver 162. The registration system assigns each user with a unique user code, and the particular device 172 may also have a unique device code associated with type of device and the application software. The codes may be configured to expire every 30 days or on an ongoing subscription basis. Different users will have different levels of access to or authorisation to operate the system. For example, some users may be authorised build, view and extract database items, some users can calibrate inputs only, and some users can actively interrogate outputs like driving damper motors.

At step 504, the system 150 is configured to determine if the user is registered with the system 150 by conducting database operations to compare the user code with a pre-determined user code stored on the database 164. At step 506, if the user is not registered with the system 150, at step 510, the user may be directed to assistance information such as a webpage.

If the user is registered with the system 150, at step 512, the system 150 further requests and receives the identification data, in this example provided as a QR-code, to perform a second stage authorisation, at step 514. The second stage authorisation includes the system 150 determining a user level authority by comparing the user code with the QR-code of the sensor 152. This determines what level of authority the user may have and if the user is authorised to perform the calibration of the sensor identified by the particular QR-code. At step 516, if the user does not have the required authority the system 150, at step 510, the user may be directed to assistance information such as a webpage, and of the user has the required user level authority the sub-routine returns to the main routine.

Referring now to FIG. 7, the calibration validity routine 210, 310 is described in further detail as method 600. At step 602, the system 150 receives information including a calibration sensor device code. This system 150, preferably server processing system 160, performs processing and database operations to determine, using the calibration device code, if the particular calibration sensor device 174 has a current calibration certificate located on or registered with the system 150.

It is noted the system 150 includes a calibration certificate register, preferably on the server database 164. The calibration certificate register may contain calibration certificate data (or an electronic calibration certificate) issued in respect of a particular calibration sensor device 174 that is identified by the unique calibration sensor device code. To update the calibration certificate data maintenance personnel or contractors may perform annual calibrations on the sensing device 174. The certified calibration contractor updates the calibration “certificate” via the website for storage on the server database 164. This updates the database 164 to allow users to use the calibration sensor device 174 for field calibration of the building sensors 152.

At step 608, if the calibration certificate is valid or current, system 150 returns a valid calibration certificate signal, at step 608, and the routine returns to the main routine at step 610. If the calibration certificate is not valid or current, at step 612, the user may be prompted to identify, upload or update the calibration certificate data. At step 616, if the calibration certificate data identified, uploaded or updated then the routine returns to step 606 to confirm the validity of the certificate. If the calibration certificate is not identified, uploaded or updated then, at step 614, the routine returns to start of the main routine 614 and may be configured to provide an error message or signal.

Advantageously, there has been described a system and method for the identification and calibration of a sensor in communication with a Building Management System (BMS). The system and method allow one or more sensors in a building to be identified by the system and the system is configured to retrieve sensor data from the BMS. The system and method also allow a sample or calibration measurement to be made using a calibration sensor device proximate to the sensor and for the calibration sensor data to be recorded for the particular building sensor. The system and method then perform data operations to calculate an offset or difference between the sensor data from the BMS and the calibration sensor data. The offset or calibration data is then ultimately written to the BMS database to calibrate the sensor data received from the sensor. The system and method are also advantageously configured to ensure that the calibration sensor device is itself calibrated, for example, by checking for a calibration certificate, and that the user has authority to calibrate the sensors in communication with the BMS.

Accordingly, the system and method may be configured to operate with existing BMS systems and provide a rapid, accurate and cost effective system and method to calibrate sensor data on the BMS database.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

We claim:

1. A method for calibration of a sensor of a building using a computer system, the method including the steps of:
a) Receiving, at the computer system, sensor identification data, the identification data provided by communication of an identifier associated with the sensor and an identification device configured to communicate with the system;
b) Receiving, at the computer system, measured data representing a calibration sensor device measured physical phenomenon provided by communication of a portable calibration sensor device with an environment proximate to the sensor, the portable calibration sensor device being configured to communicate with the computer system; and
c) Receiving, at the computer system, sensor data associated with the identification data of the sensor, the sensor data representing a sensor measured physical phenomenon provided by the sensor;
d) Calculating, in the computer system, a difference value between the measured data and the sensor data so as to provide calibration data.

2. The method according to claim 1, wherein the method further includes the step of:
Storing, in the computer system, the calibration data including the difference value in a database such that the sensor data is offset in value to substantially match the measured data.

3. The method according to claim 1, wherein the method further includes the step of:
Receiving, at the computer system, device authorisation data associated with at least one of the identification device and the portable calibration sensor device; and
Determining, a device authority associated with the device authorisation data by comparing the device authorisation data with pre-determined device authorisation data, the device authority enabling calibration of the sensor data.

4. The method according to claim 1, wherein the method further includes the steps of:
Receiving, at the computer system, user authorisation data associated with a user of at least one of the identification device and the portable calibration sensor device; and
Determining, a user authority associated with the user authorisation data by comparing the user authorisation data with pre-determined user authority data, the user authority enabling calibration of the sensor data.

5. The method according to claim 1, wherein the method further includes the steps of:
Receiving, at the computer system, calibration validity data associated with the portable calibration sensor device; and
Determining, in the computer system, a calibration validity associate with the calibration validity data by comparing the calibration validity data with pre-determined calibration validity data, the calibration validity enabling calibration of the sensor data.

6. The method according to claim 1, wherein the identifier is an optically readable code and the identification device is a camera of a mobile device.

7. The method according claim 1, wherein the portable calibration sensor device is at least one of a temperature, light, pressure and gas sensor.

8. The method according claim 1, wherein the first and second physical phenomenon measurements are each at least one of temperature, light, pressure and gas levels.

9. A method for calibration of sensor data on a building management system database using a computer system configured to interface with the building management system, the method including, in the computer system the steps of:
a) Receiving, sensor identification data, the identification data provided by communication of an identifier associated with the sensor and an identification device configured to communicate with the system;
b) Receiving, measured data representing a calibration sensor device measured physical phenomenon provided by communication of a portable calibration sensor device with an environment proximate to the sensor, the portable calibration sensor device being configured to communicate with the system; and
c) Receiving, from a database of the building management system, sensor data associated with the identification data of the sensor, the sensor data representing a sensor measured physical phenomenon provided by the sensor identified;
d) Calculating, in the computer system, a difference value between measured data and the sensor data so as to provide calibration data;
e) Sending, the calibration data including the difference value to the building management system database such that the sensor data is offset in value to substantially match the measured data.

10. A system for the identification and calibration of a sensor of a building, the system including a mobile computing system and a server system,
wherein the mobile computing system includes an identification device configured to read an identifier associated with the sensor to provide identification data, and a calibration sensor device configured to sample a first physical phenomena proximate to the sensor so as to provide calibration sensor data representative of the first physical phenomena, and
wherein the server system includes a server and a database, the server being configured to receive the identification data and the calibration sensor data, and retrieve sensor data associated with identification data from the database, the sensor data representing a second physical phenomena as measured by the sensor of the building, and
wherein the server is further configured to calculate a difference value between the calibration sensor data and the sensor data so as to provide calibration data and store the calibration data including the difference value in the database such that the sensor data is offset in value to substantially match the calibration sensor data.

11. The system according to claim 10, wherein the system is configured to:
Receive device authorisation data associated with at least one of the identification device and the calibration sensor device; and
Determine, a device authority associated with the device authorisation data by comparing the device authorisation data with pre-determined device authorisation data, the device authority enabling calibration of the sensor data.

12. The system according to claim 10, wherein the system is configured to:
Receive user authorisation data associated with a user of at least one of the identification device and the calibration sensor device; and
Determine a user authority associated with the user authorisation data by comparing the user authorisation data with pre-determined user authority data, the user authority enabling calibration of the sensor data.

13. The method according to claim 10, wherein the system is configured to:
Receive calibration validity data associated with the portable calibration sensor device; and
Determine a calibration validity associate with the calibration validity data by comparing the calibration validity data with pre-determined calibration validity data, the calibration validity enabling calibration of the sensor data.

14. The system according to claim 10, wherein the identifier is an optically readable code and the identification device is a camera of a mobile device.

15-18. (canceled)
